(19) United States
(12) Patent Application Publication
(10) Pub. No.: US 2011/0219449 A1
(43) Pub. Date: Sep. 8, 2011

(54) MALWARE DETECTION METHOD, SYSTEM AND COMPUTER PROGRAM PRODUCT

(76) Inventors: Michael St. Neitzel, Maidenhead (GB); Eric Sites, Clearwater, FL (US)

(21) Appl. No.: 12/717,325

(22) Filed: Mar. 4, 2010

(51) Int. Cl. G06F 11/00; G06F 21/00

(52) U.S. Cl. 726/23

(57) ABSTRACT

A method, electronic device and computer program product for real-time detection of malicious software (“malware”) are provided. In particular, execution of a suspicious software application attempting to execute on a user's device may be emulated in a virtual operating system environment in order to observe the behavior characteristics of the suspicious application. If after observing the behavior of the suspicious application in the virtual environment, it is determined that the application is malicious, the application may not be permitted to execute on the user's actual device. The suspicious application may be identified as malicious if an isolated data string of the application matches a “blacklisted” data string, a certain behavior of the application matches a behavior that is known to be malicious, and/or the overall behavior of the application is substantially the same or similar to a known family of malware.

### FIELD

Embodiments of the invention relate, generally, to detecting malicious software (i.e., “malware”) and, in particular, to real-time behavior-based detection of malware.

### BACKGROUND

Malicious software (“malware”) can come in many different forms, including, for example, viruses, worms, Trojans, and/or the like. Within each of these categories of malware, there can be many different families of malicious applications that each includes multiple versions or variants of the same application (i.e., multiple “family members”), each with slight variations. To make things even more complicated, each instance of a particular family member may be slightly different than another instance of the same family member. Because of the high degree of variation possible in different malware applications and the rate at which new variants are being developed at all times, malware detection can be very difficult.

One technique that alleviates some of the difficulty is to focus on the behavior of a particular software application, rather than the exact data components (e.g., is it attempting to manipulate a system file, rather than does it have a specific signature). This can be useful because while there may be differences between each of the different instances of a malware application, certain behavior characteristics are fairly typical for all malware and/or for malware belonging to a particular family.

In order to look at a software application's behavior, though, the application has to be executed. However, if malware is allowed to execute on a user's device, the device may already be compromised. In fact, certain malware applications may be configured to deactivate an anti-virus protection application as soon as they are executed. One way to look at the behavior of a suspicious software application without executing the application on a user's actual device is to emulate the execution of the software application in a virtual environment.

However, emulating the execution of a software application can require the execution of billions of software instructions. The processing power and time required to perform these instructions has thus far prevented using this technique in real time, or in response to and at the moment an application is attempting to execute on the user's device, for example, when the user attempts to open or download a particular file.

A need, therefore, exists for a technique whereby malware applications can be detected in real-time based on their particular behavior characteristics.

### BRIEF SUMMARY

In general, embodiments of the present invention provide an improvement by, among other things, providing a method, electronic device and computer program product for real-time detection of malicious software (“malware”), wherein execution of a suspicious software application may be emulated in a virtual operating system (e.g., Microsoft® Windows® compatible) environment in order to observe the behavior characteristics of that application in a “safe” environment. In one embodiment, emulation may occur in response to the suspicious application attempting to execute on the user's electronic device, and before the application is allowed to execute on the actual device (i.e., in “real-time”). If after observing the behavior of the suspicious application in the virtual environment, the simulation and detection system of embodiments described herein determines that the application is malicious, the application may not be permitted to execute on the user's actual device. As described in more detail below, the suspicious application may be identified as malicious if, for example, an isolated data string of the application matches a “blacklisted” data string, a certain behavior of the application matches a behavior that is known to be malicious, and/or the overall behavior of the application is substantially the same or similar to a known family of malware.

In accordance with one aspect, a method is provided of detecting malicious software. In one embodiment, the method may include: (1) receiving an indication that a software application is attempting to execute on a user's device; (2) emulating, by a processor, the software application in a virtual environment, in response to receiving the indication; (3) analyzing, by the processor, one or more behavior characteristics of the emulated software application; and (4) identifying the software application as malicious based at least in part on the behavior characteristics analyzed.

In accordance with another aspect, an electronic device is provided for detecting malicious software. In one embodiment, the electronic device may include a processor configured to: (1) receive an indication that a software application is attempting to execute on a user's device; (2) emulate the software application in a virtual environment, in response to receiving the indication; (3) analyze, one or more behavior characteristics of the emulated software application; and (4) identify the software application as malicious based at least in part on the behavior characteristics analyzed.

In accordance with yet another aspect, a computer program product is provided for detecting malicious software. The computer program product contains at least one computer-readable storage medium having computer-readable program code portions stored therein. The computer-readable program code portions of one embodiment include: (1) a first executable portion for receiving an indication that a software application is attempting to execute on a user's device; (2) a second executable portion for emulating the software application in a virtual environment, in response to receiving the indication; (3) a third executable portion for analyzing one or more behavior characteristics of the emulated software application; and (4) a fourth executable portion for identifying the software application as malicious based at least in part on the behavior characteristics analyzed.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as a user's electronic device in accordance with embodiments of the present invention;

FIG. 2 is a flow chart illustrating the overall process for detecting malicious software in accordance with embodiments of the present invention;

FIG. 3 is a flow chart illustrating the process of initializing a virtual operating system environment in accordance with an embodiment of the present invention; and

FIG. 4 is a flow chart illustrating the process of emulating the execution of suspicious software in a virtual environment in real time in order to determine whether the software is malicious in accordance with an embodiment of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overall System and Electronic Device

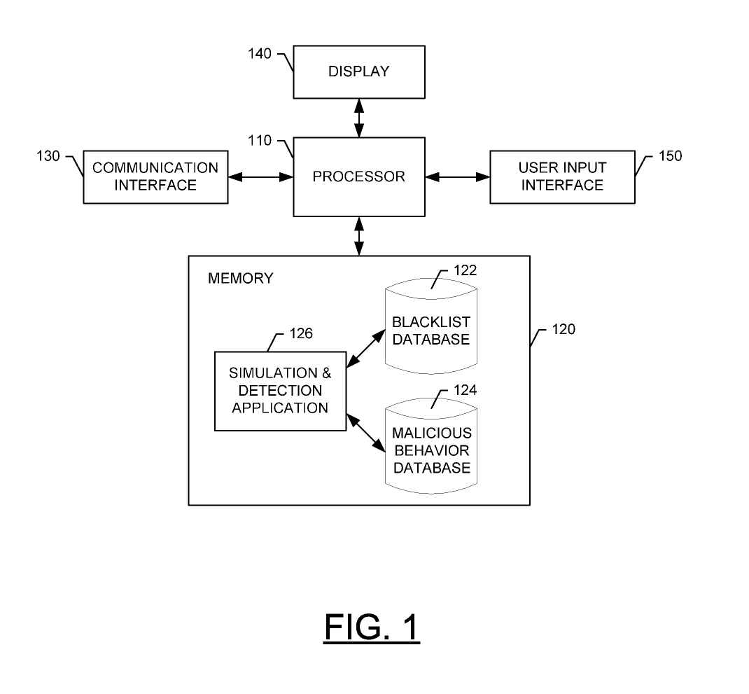

Referring now to FIG. 1, a block diagram of an entity capable of operating as a user's electronic device 100, on which the simulation and detection system of embodiments described herein is executing, is shown. The electronic device may include, for example, a personal computer (PC), laptop, personal digital assistant (PDA), and/or the like. The entity capable of operating as the user's electronic device 100 may include various means for performing one or more functions in accordance with embodiments of the present invention, including those more particularly shown and described herein. It should be understood, however, that one or more of the entities may include alternative means for performing one or more like functions, without departing from the spirit and scope of embodiments of the present invention. As shown, the entity capable of operating as the user's electronic device 100 can generally include means, such as a processor 210 for performing or controlling the various functions of the entity.

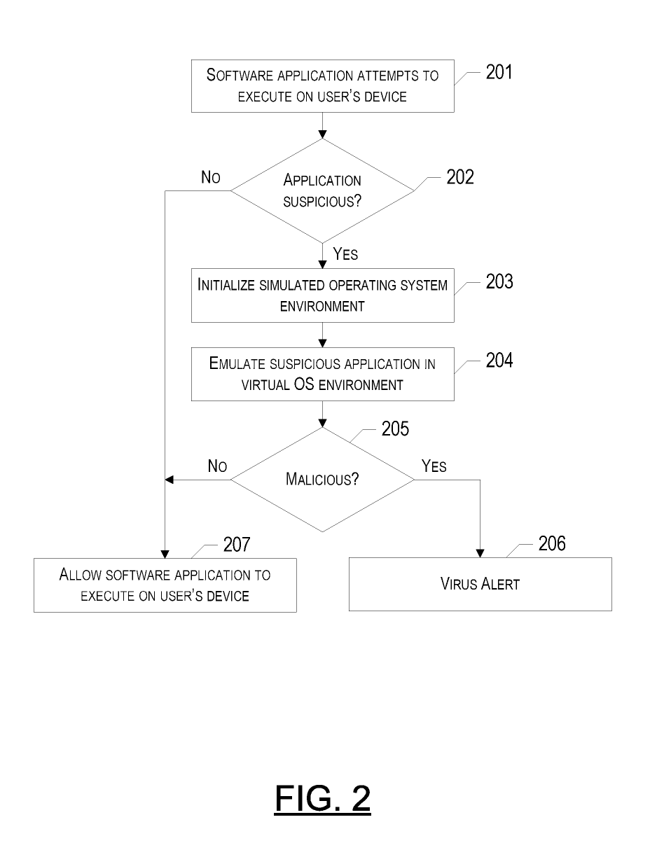

In particular, the processor 110 may be configured to perform the processes for real-time detection of malware discussed in more detail below with regard to FIGS. 2-4. For example, according to one embodiment the processor 110 may be configured to receive an indication that a software application is attempting to execute on the user's device 100 and, in response, to emulate the application in a virtual environment, such that one or more behavior characteristics of the emulated software application can be analyzed. The processor 110 may further be configured to identify the software application as malicious based at least in part on the behavior characteristics analyzed.

In one embodiment, the processor is in communication with or includes memory 120, such as volatile and/or non-volatile memory that stores content, data and/or the like. For example, the memory 120 may store content transmitted from, and/or received by, the entity. In particular, according to one embodiment, the memory 120 may store a blacklist database 122 and/or a malicious behavior database 124. As described in more detail below, in one embodiment, the blacklist database 122 may include a plurality of string type and string data pairs that are known to be malicious. Examples of string types that may be stored in the blacklist database 122 may include, for example, a mutex string, a window/dialog string, a file/object string, a registry string, a URL/domain string, a string operation, a process/task string, and/or the like, wherein the string data may include, for example, the title of a window or dialog box being generated, the name of a file, object or registry key being created, the URL or domain name of a website being accessed, and/or the like. Similarly, according to one embodiment discussed in more detail below, the malicious behavior database 124 may store a plurality of behaviors that are known to be malicious (e.g., copying an uncertified file into a system folder without user interaction).

Through the use of databases to store known malicious data strings and/or behaviors, embodiments of the present invention can be easily and quickly updated as new malicious software applications are discovered. As one of ordinary skill in the art will recognize in light of this disclosure, while FIG. 1 illustrates separate blacklist and malicious behavior databases 122, 124, embodiments of the present invention are not limited to this particular structure. In contrast, a single or multiple databases may similarly be used without departing from the spirit and scope of embodiments described herein.

The memory 120 may further store software applications, instructions or the like for the processor 110 to perform steps associated with operation of the entity in accordance with embodiments of the present invention. In particular, the memory 120 may store software applications, instructions or the like for the processor 110 to perform the operations described above and below with regard to FIGS. 2-4 for real-time detection of malware. For example, according to one embodiment, the memory 120 may store a simulation and detection application 126 configured to instruct the processor 110 to, in response to receiving an indication that a software application is attempting to execute on the user's device 100, emulate the application in a virtual environment, such that one or more behavior characteristics of the emulated software application can be analyzed. The simulation and detection application 126 may further be configured to instruct the processor 110 to identify the software application as malicious based at least in part on the behavior characteristics analyzed.

According to one embodiment, the simulation and detection application 126 may comprise one or more modules for instructing the processor 110 to perform the operations for simulating an operating system (e.g., Windows®) environment and for emulating the execution of a suspicious application in the virtual environment in order to determine whether the suspicious application is malicious. The modules may include, for example, a registry module, a file system module, a windows and desktop module, a process and task module, an Internet module, a database string match module, a behavior rules module, and a family detection module. As one of ordinary skill in the art will recognize in light of this disclosure, the foregoing list of modules, which are described in more detail below, are provided for exemplary purposes only and should not be taken in any way as limiting the simulation and detection application 126 of embodiments described herein to the particular modules described. In fact, the simulation and detection application 126 need not be modular at all to be considered within the spirit and scope of embodiments described herein.

In one embodiment, the registry module may be responsible for all registry-related operations associated with simulation and emulation including for example, opening, reading, creating, deleting and enumerating registry keys and values. In one embodiment, the registry module may create and update a Windows®, or similar operating system, compatible Default Registry set, wherein the registry keys and data can be easily extended, for example, via use of a database.

In one embodiment, the file system module make be responsible for all file in/out operations associated with simulation and emulation including, for example, opening, reading, creating, deleting and listing files and/or directories. In one embodiment, the simulation and detection application 126, and, in particular, the file system module, may simulate advanced file attributes, such as Filetime, Creationtime, File Attributes, and/or ADS (i.e., Alternate Data Streams in the Windows New Technology File System (NTFS)). In one embodiment, the file system module may support network access and Raw Device Access (e.g., over Registry). The file system module may further use universal naming convention (UNC)-paths for the foregoing operations.

In one embodiment, the window and desktop module of the simulation and detection application 126 may be responsible for all window-, dialog-, and desktop-related functions associated with simulating the operating system environment and emulating execution of the suspicious software therein. These functions may include, for example, all operations or tasks involving the use of a Graphical User Interface (GUI), such as creating new windows and/or dialog boxes including typical window controls, such as buttons, sliders and/or input fields.

The process and task module of one embodiment may be responsible for all process- and task-related functions associated with simulation and emulation including, for example, keeping track of which applications and services are currently running and which window handles and physical files are associated with the process.

In one embodiment, the Internet module may be configured to take care of all communication functions associated with simulating the operating system environment and emulating execution of the suspicious software therein including, for example, file downloading, IP address resolution, file uploading, direct socket communication and email functionality. In one embodiment, the simulation and detection application 126 may be configured to simulate its own Internet so that a real Internet connection is not necessary on the user's device 100. In particular, according to one embodiment, the simulation and detection application 126 may instruct the processor 110 to create dummy files for downloaded files and to evaluate what the suspicious software application tried to do with those files.

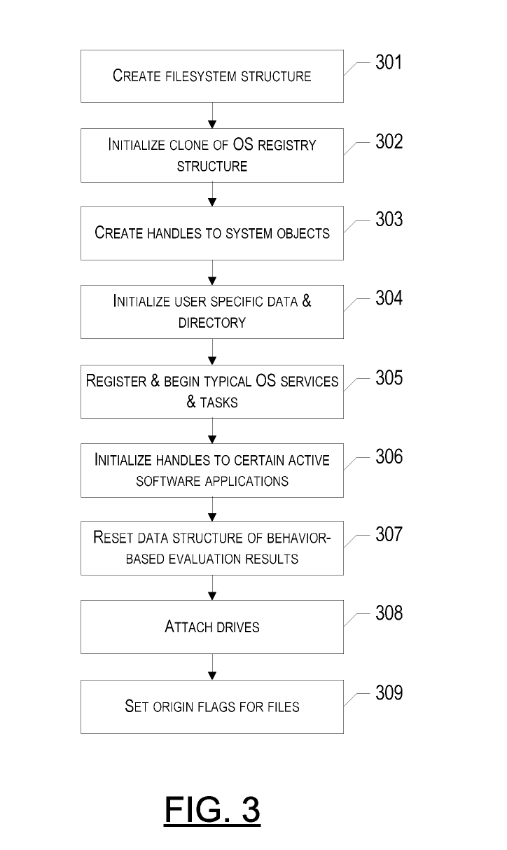

The database string match module, the functionality of which is described in more detail below with regard to FIG. 3, may be configured to intercept each Application Program Interface (API) functionality call performed by the emulated software application and to isolate a data string associated with that API call. The data string may include, for example, a string type (e.g., window/dialog string, file/object string, etc.), as well as string data (e.g., the window/dialog title, the file/object name, etc.). The database string match module may thereafter be configured to access the blacklist database 122 in order to determine whether the isolated data string matches a string type and data pair stored in the database 122. If so, the application may be identified as malicious.

In one embodiment, as described in more detail below with regard to FIG. 3, the behavior rules module of the simulation and detection application 126 may similarly be configured to isolate a behavior or a behavior characteristic of the suspicious software application and to access the malicious behavior database 124 in order to determine whether the isolated behavior is known to be malicious. If so, the suspicious application may, itself, be identified as malicious.

Further, in one embodiment discussed in more detail below with regard to FIG. 3, the family detection module of the simulation and detection application 126 may be configured to compare the behaviors of the emulated suspicious software application to one or more sets of behaviors known to be characteristic of a corresponding one or more malware families and to increase or decrease a Family Point Total associated with each family based on the comparison. If, at the end of the emulation, the Family Point Total for a particular family of malware exceeds some predefined threshold number, the family detection module of one embodiment may be configured to identify the suspicious software application as malicious and as belong to that particular family.

Returning to FIG. 1, in addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the entity to receive data from a user, such as a keypad, a touch display, a joystick or other input device.

### Method of Detecting Malware in Real Time

Referring now to FIGS. 2-4, the operations are illustrated that may be taken in order to use emulation and behavior-based detection to identify malicious software (“malware”) in real time. As shown, the process may begin at Block 201 when the simulation and detection system of embodiments described herein (e.g., a processor 110 executing a simulation and detection application 126) receives an indication that a software application is attempting to execute on the user's device 100 (e.g., PC, laptop, PDA, etc.). This may, for example, be in response to the user double clicking, or otherwise attempting to open or download, a file or application. Upon receiving the indication, the processor 110 may be configured to first determine, at Block 202, whether the application attempting to execute on the user's device looks “suspicious.” In one embodiment, this may involve, for example, determining whether the file that the user is attempting to open or download is considered a “safe file.” An example of a “safe file” may include a system file and/or a file having a certificate associated therewith. In one embodiment, a list of known “safe files” may be stored in the memory 120 on the user's device 100, wherein determining whether the file is safe may include determining whether the file is included in the saved list.

If the file is identified as safe, or the processor 110 otherwise determines that the software application is not suspicious, the process may continue to Block 207, where the application is allowed to execute on the user's device. If, however, the processor 110 determines that the application is suspicious, the process may continue to Block 203 where a simulated operating system (e.g., Microsoft Windows) environment may be initialized. In particular, according to embodiments of the present invention, the processor 110 (e.g., executing the simulation and detection application 126) may be configured to simulate Windows®, or a similar operating system, functionality in order to create a virtual environment in which execution of the suspicious software application can be emulated. In one embodiment, the processor 110 may emulate all operating system functionality that is relevant to the suspicious software application including, for example, a registry, a file system, a graphical user interface (GUI), service handling, Internet and communication handling, and/or the like. The process of initializing the simulated operating system environment in accordance with one embodiment of the present invention is discussed in more detail below with regard to FIG. 3.

Once the virtual operating system environment has been initialized, the processor 110 (e.g., executing the simulation and detection application 126) may, at Block 204, emulate the execution of the suspicious software application in the virtual operating system environment in order to analyze the behavior of the suspicious application and determine, at Block 205, whether the suspicious application is malicious.

As noted above, emulating the execution of a software application can require the execution of billions of software instructions, and the processing power and time required to perform these instructions has thus far prevented using this technique in real time, or at the moment a suspicious application is attempting to execute on a user's device. In particular, typical malware detection systems attempting to emulate a suspicious application have only been able to perform roughly 10-12 million instructions per second (mips). As a result, emulation of an entire suspicious application in order to determine whether it is malicious could take hours. It is not reasonable to prevent a user from executing an application for several hours while the malware detection system determines whether the application is malicious. Thus, emulation has thus far not been performed in real time.

Embodiments of the present invention overcome this issue through the use of dynamic translation. As one of ordinary skill in the art will recognize in light of this disclosure, dynamic translation refers to the translation and caching of a basic block of computer code, such that the code is only translated as it is discovered and, when possible, branch instructions are made to point to already translated and saved code. Use of dynamic translation enables the malware detection system of embodiments described herein to perform upwards of 400 mips, as compared to the 10-12 mips performed by most existing malware detection systems. As a result, the malware detection system of embodiments described herein is capable of being used in real time.

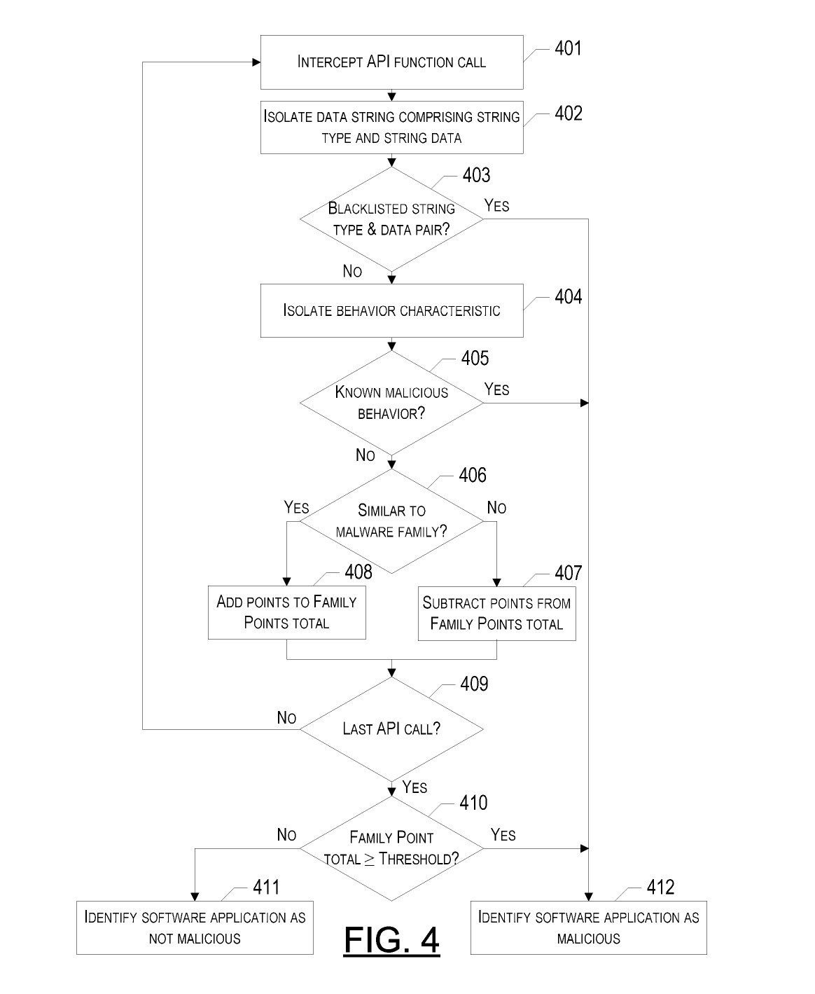

According to embodiments of the present invention, in order to determine whether the suspicious software application being emulated in the virtual operating system environment is malicious, the behavior of the suspicious software application may be observed by the processor 110. As described in more detail below with regard to FIG. 4, in one embodiment, the processor 110 may identify the suspicious application as malicious if (1) a data string of the suspicious application matches a “blacklisted” data string; (2) a behavior of the suspicious application matches a rule that identifies behavior known to be malicious; and/or (3) the overall behavior of the suspicious application resembles that of a known malware family.

If it is determined, at Block 205, that the suspicious software application is malicious, according to one embodiment, the processor 110 may, at Block 206, cause a virus alert to be displayed to the user and prevent the application from executing on the user's device 100. Alternatively, if the processor 110 does not identify the suspicious application as malicious, the processor 110 may, at Block 207, simply allow the application to execute on the user's device 100, as originally initiated.

Turning now to FIG. 3, a more detailed description of the process for initializing the simulated operating system environment (Block 203 above) in accordance with one embodiment of the present invention is provided. As shown, the process may begin at Block 301 when the processor 110 (e.g., executing the simulation and detection application 126) may create a virtual file system structure that mirrors, or at least closely resembles, that of the operating system of the actual user's device 100. In one embodiment, this may include, for example, creating a virtual “rubber-drive” C, which may expand the needed space dynamically, as well as installing in the correct folder structure various cloned system files (e.g., Notepad, Calculator, etc.) and/or user files (e.g., itunes, Mozilla Firefox®, etc.). In one embodiment, the processor 110 may further simulate well known security software (e.g., Antivirus Programs and/or Firewall Software).

The processor 110 may then initialize a clone of the registry structure of the actual user device operating system (Block 302), and create one or more handles to system objects (e.g., system fonts, system cursors, etc.) (Block 303). Next, the processor 110 (e.g., executing the simulation and detection application 126) may initialize certain user-specific data and directories (e.g., personal document folders, etc.) that may be relevant to the suspicious software, register and begin certain common or typical operating system services and tasks (e.g., by simulating SVCHOST.EXE, SMSS.EXE, etc.), and initialize certain window and/or desktop handles to active software applications (e.g., an active Internet browser operating in the foreground). (Blocks 304-306).

The processor 110 may then reset the data structure of behavior-based evaluation results, such that a new suspicious application can be evaluated; attach network, fixed and/or removable drives based on the desired configuration of the virtual environment; and set an “origin” flag for one or more files in the virtual environment (e.g., a Zone Alarm Clone Executable file may hold the flag “Security Software,” whereas Firefox® may hold the flag “User Application”). (Blocks 307-309).

According to one embodiment, the foregoing steps, which may only take a couple of milliseconds to perform, may be performed in order simulate all functionality of the actual user device operating system that may be relevant to the suspicious software application. Once complete, the processor 110 (e.g., executing the simulation and detection application 126) may be prepared to emulate the execution of the suspicious software in the virtual environment.

As one of ordinary skill in the art will recognize in light of this disclosure, the steps of the foregoing process for initializing the virtual operating system environment in order to analyze the behavior of a suspicious application need not be performed in the exact order provided above.

As discussed above, once the simulated operating system environment has been initialized (whether once or each time a suspicious application attempts to execute on the user's device), the processor 110 (e.g., executing the simulation and detection application 126) may be configured to emulate the suspicious software application in the virtual environment in order to determine whether the suspicious application is, in fact, malicious. A more detailed description of the process for performing this emulation and making this determination in accordance with an embodiment of the present invention will now be described with reference to FIG. 4.

As shown, the process may begin at Block 401 when the simulation and detection system (e.g., a processor 110 executing the simulation and detection application 126) intercepts an Application Program Interface (API) function call made by the suspicious application to the virtual operating system. As one of ordinary skill in the art will recognize in light of this disclosure, an API call may include any action requested by the suspicious application including, for example, a request to generate a file, open a window or dialog box, create a registry key, and/or the like.

Upon intercepting the API call, the processor 110 (e.g., executing the database string match module of the simulation and detection application 126) may, at Block 402, isolate a data string from the API call, wherein the data string may include a string type and string data. As noted above, examples of string types may include a mutex string (e.g., used to avoid multiple instances of the same process or task), a window/dialog string (e.g., an instruction to open a window with the window title “My Email Worm”), a file/object string (e.g., an instruction to create a file named “Trojan Horse”), a registry string (e.g., an instruction to create a registry key named “Roach”), a URL/domain string (e.g., an instruction to access a website having a specific URL and/or domain name), a string operation, a process/task string (e.g., an instruction to manipulate or dominate a specific application), and/or the like, wherein the string data may include, for example, the title of a window or dialog box being generated, the name of a file, object or registry key being created, the URL or domain name of a web site being accessed, the name of the application being manipulated, and/or the like.

At Block 403, the processor 110 (e.g., executing the database string match module) may access the blacklist database 122 to determine whether the isolated data string matches a string type and data pair stored in the database 122. In other words, the processor 110 may determine whether the instruction requested by the suspicious software includes a “blacklisted” data string, or a data string known to be malicious.

If so, the processor 110 of one embodiment may, at Block 412, immediately identify the overall suspicious software application as malicious and display a virus alert to the user (FIG. 2, Block 206). In other words, according to one embodiment, once a malicious behavior has been observed (e.g., a request to generate a file known to be malicious), emulation and evaluation may be stopped in order to speed up performance when scanning potentially malicious files. According to another embodiment, not shown, rather than immediately identifying the suspicious application as malicious, the processor 110 may, instead, increase a point total associated with the suspicious software application (e.g., a Family Point total discussed below) and continue emulating through the entire application. In this embodiment, the suspicious software application may be identified as malicious if, at the end of the emulation, the point total exceeds some predefined threshold value.

Returning to FIG. 4, if the string type and string data of the isolated data string do not match a string type and data pair stored in the blacklist database 122, the processor 110 (e.g., executing the behavior rules module of the simulation and detection application 126) may isolate the behavior characteristic associated with the API function call and determine whether the behavior characteristic matches one of the known malicious behaviors stored in the malicious behavior database 124. (Blocks 404 and 405).

The following provides a non-exclusive list of examples of behaviors that may be immediately identified as malicious in accordance with one embodiment of the present invention:

1. File copies itself without any user interaction into a system folder and is not a certified and trusted file (e.g., files from major companies, such as Microsoft, may not be detected even if they copy themselves into a system folder);

2. File copies itself without any user interaction into an operating system (e.g., Windows®) folder and is not a certified and trusted file;

3. File downloads other files directly into a system folder and is not a certified and trusted file;

4. File downloads other files directly into an operating system (e.g., Windows®) folder and is not a certified and trusted file;

5. File makes more than an allowed number of self-copies across the system;

6. File downloads one or more executables via sockets (e.g., via WinSock) and the executable that tries to download that file is very small and starts the downloaded content directly after downloading;

7. File tries to change file attributes of files created by the suspicious application, such that the files appear to be hidden or system files;

8. File tries to delete known security software;

9. File adds autorun registry keys, uses sockets (e.g. WinSock), and opens ports to listen;

10. File adds itself to Winlogon Registry keys (excludes the files that are valid);

11. File manipulates one or more system files (could indicate a possible virus infection);

12. File manipulates one or more so called victim files (could indicate possible virus infection);

13. File closes or manipulates one or more window or dialog classes that belong to security software;

14. File performs malicious code injection into one or more other running processes;

15. File creates new executables in an operating system (e.g., Windows®) or system folder and executes the created executables directly afterwards and is not a certified and trusted file;

16. File deletes one or more system files without any user interaction;

17. File moves one or more system files to other locations;

18. File terminates security software (e.g., via TerminateProcess API);

19. File changes, without any user interaction, the default browser homepage; and/or

20. File stops or deletes security related system services.

As shown by the above list, according to one embodiment, the malicious behaviors may include a single behavior (e.g., attempting to change an attribute of a self-created file to hidden or system) or two or more behaviors that, when combined, indicate malicious behavior (e.g., self-copying a file across the system more than some predefined number of times). As one of ordinary skill in the art will recognize in light of this disclosure, the foregoing examples of known malicious behaviors are provided for exemplary purposes only and should not be taken in any way as limiting embodiments of the present invention to the particular examples provided. Other behaviors may similarly be identified as malicious, while some of those listed may not be considered malicious without departing from the spirit and scope of embodiments described herein.

If it is determined that the behavior characteristic matches a known malicious behavior, the processor 110 of one embodiment may proceed to Block 412 where the overall suspicious software application may be immediately identified as malicious and a virus alert may be displayed to the user (FIG. 2, Block 206). As above, this immediate identification of a suspicious software application as malicious upon the detection of a malicious behavior, without the need to emulate the entire application, may speed up performance of the simulation and detection application 126 of embodiments described herein. Also as above, while not shown, in another embodiment, the processor 110 may, instead, increase a point total associated with the suspicious software application upon identification of a known malicious behavior, continue to emulate through the entire application, and then identify the suspicious application as malicious only if, at the end, the point total exceeds some predefined threshold.

If the behavior characteristic does not match a known malicious behavior, the processor 110 (e.g., executing the family detection module of the simulation and detection application 126) may, at Block 406, determine whether the isolated behavior, while not immediately identified as malicious in and of itself, is similar to a behavior known to be associated with a particular family of malware applications. In particular, according to one embodiment, each of a plurality of different malware families may have a set of behaviors that are known to be typical for that family. The processor 110 may compare the behavior of the suspicious application to each of these sets of behaviors in order to determine whether the suspicious application looks like or resembles one of the known malware families.

If it is determined that the behavior is similar to a set of behaviors associated with one of the malware families, the processor 110 (e.g., executing the family detection module) may add points to a Family Point total associated with that family. (Block 407). Conversely, if the behavior characteristic is dissimilar to the set of behaviors, the processor 110 (e.g., executing the family detection module) may subtract points from the corresponding Family Point total. According to one embodiment, a plurality of Family Point totals may be accumulating with respect to the suspicious software application, one for each known malware family. Use of these Family Point totals enables embodiments of the present invention to identify an application as malware even if the exact data string and/or the exact behavior of the application is not known to be malicious, but the overall application shares the same behavior characteristics of known malware families. In other words, through the use of Family Point totals, embodiments of the present invention are capable of identifying new instances of known malware family members, as well as new family members to known malware families.

Once the Family Point totals have been updated, the processor 110 may, at Block 409, determine whether this was the last API function call of the suspicious application. In one embodiment, this may involve determining whether any “conditional bookmarks” have been set in the application to which the simulation and detection application 126 needs to return. In particular, malicious applications have been known to use anti-emulation tricks to fool an emulation system into non-malicious code or to end the program flow before the detection application is able to identify the malicious application as malware. For example, a conditional step of the malicious application may be to look for a particular file, registry key and/or the like that would only be present if the malicious application were being executed on the user's actual device, but not in a simulated environment. When the file, registry key, etc. is not found, the malicious application may simply end the program flow, or proceed to execute non-malicious instructions. When the emulation system reaches the end of the malicious application without discovering any malicious behavior, the emulation system may enable the malicious software to execute on the user's actual device.

Embodiments of the present invention overcome these tricks by setting “conditional bookmarks” within the application each time a conditional step is encountered. The processor 110 may proceed to execute the suspicious application as if the result of the conditional step were one way (e.g., file not found), but then return to the conditional bookmark if it reaches the end of the suspicious application and the suspicious application was not identified as malicious. The processor 110 may then invert the result of the conditional step (e.g., file found), and proceed through execution. In this way, embodiments of the present invention enable all possible scenarios of the suspicious application to be emulated in the safe virtual environment before the suspicious application is allowed to execute on the user's actual device. In one embodiment, a conditional bookmark may be set at each conditional step encountered. Alternatively, according to another embodiment, a conditional bookmark may only be set at some subset of the conditional steps encountered including, for example, only those conditional steps that are known to commonly indicate an anti-emulation trick.

If it is determined that the current API function call is not the last, the processor 110 (e.g., executing the simulation and detection application 126) may return to Block 401. Otherwise, if the processor 110 has reached the end of the suspicious application without having identified the application as malicious based on a particular data string or a known malicious behavior, the processor 110 (e.g., executing the family detection module) may compare each of the Family Point totals to a predefined threshold value associated with the corresponding malware family. (Block 410). If none of the Family Point totals is equal to or greater than one of the threshold values, the processor 110 may identify the software application as not malicious (Block 411) and allow the application to execute on the user's actual device (FIG. 2, Block 207).

If, however, the suspicious software application's Family Point total associated with at least one of the known malware families is equal to or greater than the corresponding threshold value, then the processor 110 may identify the suspicious application as malicious and belonging to that family of malware. (Block 412). A virus alert may thereafter be displayed to the user and he or she may not be permitted to execute the application on his or her device. (FIG. 2, Block 206).

As one of ordinary skill in the art will recognize in light of this disclosure, the steps of the foregoing process for emulating a suspicious application in a virtual environment and for analyzing the behavior of that application in order to determine whether or not the application is malicious need not be performed in the exact order provided above. For example, while the foregoing describes the processor 110 as first determining whether a data string matches a string type and data pair stored in the blacklist database 122 and then determining whether the behavior matches a known malicious behavior stored in the malicious behavior database 124, in another embodiment, the behavior may first be checked, followed by the data string. The other steps may similarly be reordered without departing from the spirit and scope of embodiments described herein.

### CONCLUSION

As described above and as will be appreciated by one skilled in the art, embodiments of the present invention may be configured as a system, method, or electronic device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. A method comprising:
receiving an indication that a software application is attempting to execute on a user's device;
emulating, by a processor, the software application in a virtual environment, in response to receiving the indication;
analyzing, by the processor, one or more behavior characteristics of the emulated software application; and
identifying the software application as malicious based at least in part on the behavior characteristics analyzed.

2. The method of claim 1 further comprising:
identifying the software application as suspicious, wherein the software application is only emulated if the software application is identified as suspicious.

3. The method of claim 2, wherein receiving an indication further comprises receiving the indication in response to the user attempting to open or download a file.

4. The method of claim 3, wherein identifying the software application as suspicious further comprises:
comparing the file to a set of one or more safe files; and
identifying the software application as suspicious if the file is not included in the set of safe files.

5. The method of claim 3, wherein identifying the software application as suspicious further comprises:
identifying the software application as suspicious if the file does not have a certificate associated therewith.

6. The method of claim 1, wherein emulating the software application further comprises:
using dynamic translation to emulate a plurality of instructions associated with the software application.

7. The method of claim 1, wherein emulating the software application further comprises:
identifying a conditional step in the software application, wherein a result of the conditional step is either true or false;
associating a conditional bookmark with the identified conditional step;
executing the software application as if the result of the conditional step were true;
returning to the conditional bookmark; and
executing the software application as if the result of the conditional step were false.

8. The method of claim 1, wherein analyzing one or more behavior characteristics further comprises:
isolating a data string of the software application, said data string comprising a string type and string data;
accessing a database comprising a plurality of string type and data pairs known to be malicious; and
identifying the software application as malicious if the string type and string data of the isolated data string is substantially the same as a string type and data pair stored in the database.

9. The method of claim 8, wherein the string type is selected from a group consisting of a window/dialog string, a file/object string, a registry string, a URL/domain string, a string operation and a process/task string.

10. The method of claim 1, wherein analyzing one or more behavior characteristics further comprises:
isolating a behavior characteristic of the software application.

11. The method of claim 10, wherein analyzing one or more behavior characteristics further comprises:
accessing a database comprising a plurality of known malicious behaviors; and
identifying the software application as malicious if the isolated behavior characteristic is substantially the same as one of the plurality of known malicious behaviors stored in the database.

12. The method of claim 10, wherein analyzing one or more behavior characteristics further comprises:
isolating a plurality of behavior characteristics of the software application;
comparing respective isolated behavior characteristics to a set of behavior characteristics associated with a known family of malicious software; and
for each isolated behavior characteristic:
increasing a family point total associated with the software application if the isolated behavior characteristic is substantially the same as or similar to a behavior characteristic in the set of behavior characteristics associated with the known family of malicious software; and
decreasing the family point total associated with the software application if the isolated behavior characteristic is dissimilar to a behavior characteristic in the set of behavior characteristics associated with the known family of malicious software.

13. The method of claim 12, wherein analyzing one or more behavior characteristics further comprises:
comparing the family point total to a threshold value associated with the known family of malicious software; and
identifying the software as malicious if the family point total is equal to or greater than the threshold value.

14. The method of claim 10, wherein the behavior characteristic is selected from a group consisting of creating or opening a file having a file name, opening a window or dialog box having a window title, accessing a web site having a URL or domain name, and accessing an application having an application name.

15. A computer program product comprising at least one computer-readable storage medium having computer-readable program code portions stored therein, said computer-readable program code portions comprising:
a first executable portion for receiving an indication that a software application is attempting to execute on a user's device;
a second executable portion for emulating the software application in a virtual environment, in response to receiving the indication;
a third executable portion for analyzing one or more behavior characteristics of the emulated software application; and
a fourth executable portion for identifying the software application as malicious based at least in part on the behavior characteristics analyzed.

16. The computer program product of claim 15, wherein the computer-readable program code portions further comprise:
a sixth executable portion for identifying the software application as suspicious, wherein the software application is only emulated if the software application is identified as suspicious.

17. The computer program product of claim 16, wherein the first executable portion is further configured to receive the indication in response to the user attempting to open or download a file.

18. The computer program product of claim 17, wherein the sixth executable portion is further configured to:
compare the file to a set of one or more safe files; and
identify the software application as suspicious if the file is not included in the set of safe files.

19. The computer program product of claim 17, wherein the sixth executable portion is further configured to:
identify the software application as suspicious if the file does not have a certificate associated therewith.

20. The computer program product of claim 15, wherein the second executable portion is further configured to:
use dynamic translation to emulate a plurality of instructions associated with the software application.

21. The computer program product of claim 15, wherein the second executable portion is further configured to:
identify a conditional step in the software application, wherein a result of the conditional step is either true or false;
associate a conditional bookmark with the identified conditional step;
execute the software application as if the result of the conditional step were true;
return to the conditional bookmark; and
execute the software application as if the result of the conditional step were false.

22. The computer program product of claim 15, wherein the third executable portion is further configured to:
isolate a data string of the software application, said data string comprising a string type and string data;
access a database comprising a plurality of string type and data pairs known to be malicious; and
identify the software application as malicious if the string type and string data of the isolated data string is substantially the same as a string type and data pair stored in the database.

23. The computer program product of claim 15, wherein the third executable portion is further configured to:
isolate a behavior characteristic of the software application.

24. The computer program product of claim 23, wherein the third executable portion is further configured to:
access a database comprising a plurality of known malicious behaviors; and
identify the software application as malicious if the isolated behavior characteristic is substantially the same as one of the plurality of known malicious behaviors stored in the database.

25. The computer program product of claim 15, wherein the third executable portion is further configured to:
isolate a plurality of behavior characteristics of the software application;
compare respective isolated behavior characteristics to a set of behavior characteristics associated with a known family of malicious software;
for each isolated behavior characteristic:
increase a family point total associated with the software application if the isolated behavior characteristic is substantially the same as or similar to a behavior characteristic in the set of behavior characteristics associated with the known family of malicious software; and
decrease the family point total associated with the software application if the isolated behavior characteristic is dissimilar to a behavior characteristic in the set of behavior characteristics associated with the known family of malicious software;
compare the family point total to a threshold value associated with the known family of malicious software; and
identify the software as malicious if the family point total is equal to or greater than the threshold value.

26. An electronic device comprising:
a processor configured to:
receive an indication that a software application is attempting to execute on a user's device;
emulate the software application in a virtual environment, in response to receiving the indication;
analyze one or more behavior characteristics of the emulated software application; and
identify the software application as malicious based at least in part on the behavior characteristics analyzed.

27. The electronic device of claim 26, wherein in order to emulate the software application the processor is further configured to:
use dynamic translation to emulate a plurality of instructions associated with the software application.

28. The electronic device of claim 26, wherein the electronic device further comprises:
a memory storing a blacklist database comprising a plurality of string type and data pairs known to be malicious, wherein in order to analyze one or more behavior characteristics, the processor is further configured to:
isolate a data string of the software application, said data string comprising a string type and string data;
access the blacklist database; and
identify the software application as malicious if the string type and string data of the isolated data string is substantially the same as a string type and data pair stored in the database.

29. The electronic device of claim 26, wherein the electronic device further comprises:
a memory storing a malicious behavior database comprising a plurality of known malicious behaviors, and wherein in order to analyze one or more behavior characteristics, the processor is further configured to:
isolate a behavior characteristic of the software application;
access the malicious behavior database; and
identify the software application as malicious if the isolated behavior characteristic is substantially the same as one of the plurality of known malicious behaviors stored in the database.

30. The electronic device of claim 26, wherein in order to analyze one or more behavior characteristics, the processor is further configured to:
isolate a plurality of behavior characteristics of the software application;
compare respective isolated behavior characteristics to a set of behavior characteristics associated with a known family of malicious software;
for each isolated behavior characteristic:
increase a family point total associated with the software application if the isolated behavior characteristic is substantially the same as or similar to a behavior characteristic in the set of behavior characteristics associated with the known family of malicious software; and
decrease the family point total associated with the software application if the isolated behavior characteristic is dissimilar to a behavior characteristic in the set of behavior characteristics associated with the known family of malicious software;
compare the family point total to a threshold value associated with the known family of malicious software; and
identify the software as malicious if the family point total is equal to or greater than the threshold value.
